(19) United States
(12) Patent Application Publication
(10) Pub. No.: US 2007/0199896 A1
(43) Pub. Date: Aug. 30, 2007

(54) Water Treatment Method And Apparatus Using Pretreatment And Membranes

(76) Inventor: Peter Temple Ballard, Glen Allen, VA (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 10/557,457

(22) PCT Filed: May 20, 2004
(86) PCT No.: PCT/US04/16031

§ 371 Date: Apr. 26, 2007

Related U.S. Application Data
(60) Provisional application No. 60/472,332, filed on May 21, 2003.

(51) Int. Cl. B01D 61/00

(52) U.S. Cl. 210/639; 210/650; 210/804; 210/702

(57) ABSTRACT

A method of treating liquid containing at least one contaminant including mixing precipitant chemical with the liquid to cause a precipitation reaction and produce a precipitant, introducing the precipitant and the liquid into a clarification device, mixing activated silica with the precipitant and liquid to cause a flocculation of the precipitant, separating the liquid from flocculated precipitant, and introducing the liquid into a membrane treatment device to cause a reduction of flocculated precipitant from the liquid.

### FIELD OF THE INVENTION

This invention relates to an apparatus and method for treating water or wastewater, particularly to an apparatus and method for treating water or wastewater utilizing chemical treatment in combination with membrane separation to achieve contaminant removal.

### BACKGROUND

There are many instances in water and wastewater treatment when membrane filtration is desirable to achieve efficient removal of contaminants, but at the same time when this membrane filtration process requires a preliminary contaminant removal step. This preliminary treatment step is necessary (a) to reduce the contaminant load on the membranes such that the membranes can be designed and operate more efficiently and/or (b) to chemically precipitate dissolved contaminants which cannot be removed by the membrane.

The preliminary treatment step utilizes and/or produces compounds which are harmful and have negative effects on the performance and/or the life of the membrane (how long the membrane can function effectively before requiring replacement). One such compound which is desirable in preliminary treatment is organic polymer. Organic polymers are used routinely in the clarification of water and wastewater to flocculate particles (i.e., to make the particles larger so that they can settle more rapidly).

Flocculation of particles is critical to the efficient design of all gravity sedimentation or clarification equipment. Without optimum flocculation, the particles are smaller and settle much slower. Consequently, the retention time of the clarifier must be substantially greater. Greater retention time equates to a much larger required volume for the clarifier, which equates further to a larger clarifier with a larger footprint. Such a larger clarifier requires substantially more space and more cost to construct. There is an obvious advantage to minimize the size of such a clarification device in order to minimize space requirements and cost of the water or wastewater treatment facility.

It follows that it is advantageous to use a flocculant in such clarification devices. As previously discussed, these flocculants which are commonly used are of an organic type (i.e., often polyacrylamides, polyamines, etc.). It is a great concern (and in fact has been documented in research and literature) that organic polymers, when used in a preliminary treatment (clarification) step prior to membranes, can impart a residual either in solution or attached to particles which subsequently attaches to the membrane surface. This organic polymer residual can and most often produces a negative effect on the membrane material. The result is that membrane performance (the flux or rate of permeability of liquid across the membrane) or membrane life (length of time which the membrane can function without physical degradation of properties such that the membrane permeability is reduced below usable levels or the membrane actually physically fails) decrease significantly.

Based on the general knowledge that organic polymers can produce a negative impact on the performance and life of nearly all membranes commonly used in water and wastewater treatment and knowing that organic polymers are required to allow efficient design and performance of preliminary treatment (clarification), there would be an obvious advantage in developing a preliminary treatment stage which does not utilize organic polymers for purpose of flocculation.

### SUMMARY OF THE INVENTION

This invention provides that advance in the art. Activated silica (which is not organic) can be used in lieu of organic polymers to produce the desired flocculation effect. Thus, the use of activated silica allows the same efficiency of design and performance in a preliminary treatment step (clarification) as afforded by organic polymers. The substantial advantage is that the residuals of this activated silica (either in solution or attached to the surface of particles which may carry over from the preliminary treatment step to the membranes) have little (as compared to organic flocculants) or no negative effect on the performance and life of the membranes.

Accordingly, one aspect of the invention relates to a method of treating a liquid including mixing a precipitation chemical with the liquid, introducing activated silica into the mixture to effect flocculation or growth of the precipitant particle size, separation of the clarified liquid and precipitant solids, and introduction of the clarified liquid into a membrane process to effect removal of residual particulate material.

### BRIEF DESCRIPTION OF THE DRAWINGS

FIG. 1 is a graph showing Whatman 2 filterability—deionized water based on volume versus time.

FIG. 2 is a graph showing Whatman 2 filterability—distilled water based on volume versus time.

FIG. 3 is a graph showing 8 μm filterability—deionized water based on volume versus time.

FIG. 4 is a graph showing 8 μm filterability—distilled water based on volume versus time.

FIG. 5 is a graph showing 0.22 μm filterability—deionized water based on volume versus time.

FIG. 6 is a graph showing 0.22 μm filterability—distilled water based on volume versus time.

FIG. 7 is a graph showing Whatman 2 filterability of unsettled treated sample based on volume versus time.

### DETAILED DESCRIPTION

This invention relates to an improved method for combined chemical pretreatment and membrane filtration of of water and wastewater. Specifically, activated silica is used to both enhance coagulation and provide flocculation. The significance and advantage of this invention for water and wastewater treatment is that the membrane is not fouled (irreversibly or reversibly) due to the use of organic polymer(s) which are typically used for flocculation. Currently, organic polymer is not commonly applied in pretreatment ahead of membranes due to the concern about irreversible fouling of the membrane and in the few instances where it has been used, the dosage of organic polymer has been carefully regulated to ensure no residual polymer reaches the membrane. The polymer or flocculant is required to enhance the size of the coagulated floc, improving settleability or flotation velocities and efficiency. The inability to utilize the organic polymer or flocculant prior to the membrane compromises the performance of the pretreatment system, often requiring substantially more conservative and expensive design.

In addition to eliminating membrane fouling due to organic polymer, the uniqueness of this process can enhance the pretreated water quality (as activated silica has unique surface characteristics which can improve (a) removal of organics, (b) removal of color, (c) improve coagulation kinetics, (d) reduced dissolved metals, and (e) improve dewaterability of the produced solids or sludge.

A better understanding of selected aspects of the invention is found by reference to the Examples below, which are non-limiting. The scope of the invention is set forth in the appended claims.

I utilized Dupont Particlear® activated silica to provide consistency of results throughout testing and conducted tests to determine the impact on filterability/fouling index for membrane feedwater as compared to organic flocculants when used with conventional coagulants such as aluminum sulfate or ferric salts. Previous testing has indicated that all floc characteristics and total and filtered turbidity are equal or better with activated silica than with organic flocculants.

### EXAMPLE 1

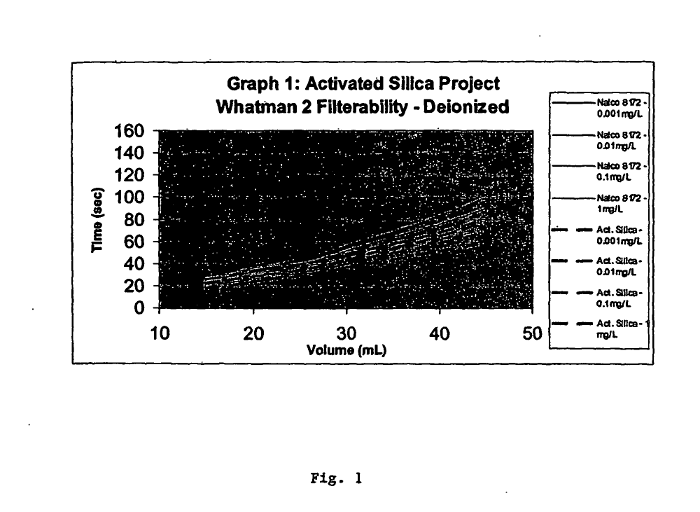

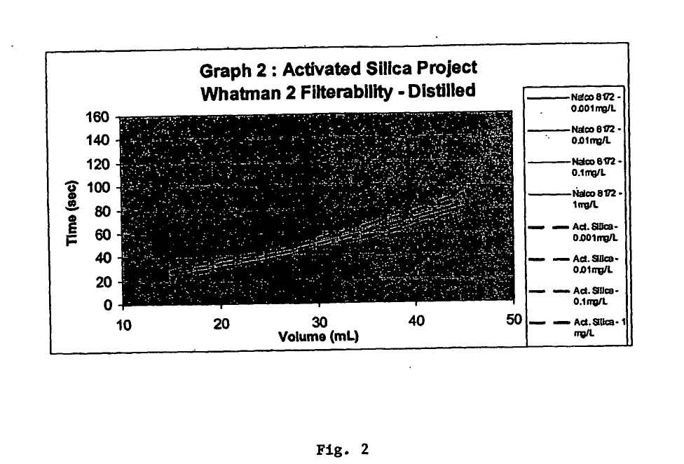

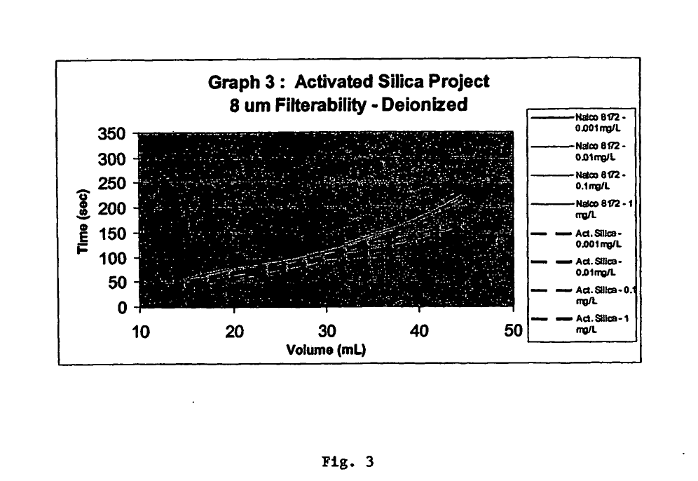

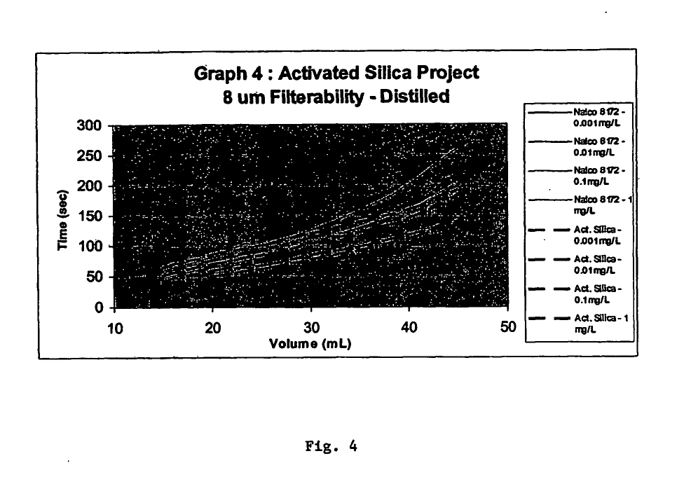

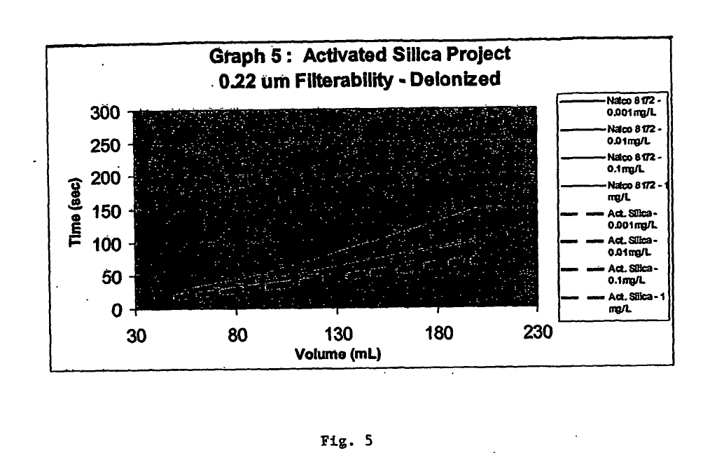

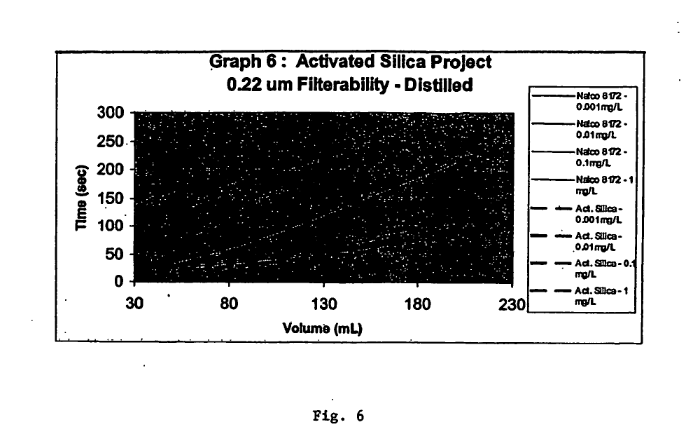

Impact on Filterability/Fouling Index. Tests were conducted to predict the impact of activated silica on the filterability or fouling tendency of clarified water. Two different tests were done. The first involved simple dissolution of polymer in de-ionized water. Nalco 8172 (high molecular weight, anionic liquid) polymer was utilized to compare performance with the activated silica. Fresh activated silica was used because the shelf-life of the product is limited. Both products were dissolved in de-ionized water at concentrations of 0.001, 0.01, 0.1, and 1 mg/l. They were then filtered through a number of filters including Whatman 2, 8 um cellulose acetate, and 0.22 um cellulose nitrate. These tests were conducted via gravity filtration for the Whatman 2 filter and via vacuum-assisted filtration for the cellulose acetate/nitrate filters. The tests were repeated with distilled water. In essentially all results, the activated silica provided greater filterability than did the organic polymer. Of particular interest are the results with the 0.22 um cellulose nitrate filter, which has a pore size approximately 10× the pore size of the actual Aquasource UF cellulose acetate membrane. The filterability of the activated silica water was substantially higher than that of the Nalco 8172 water at the lowest concentrations (0.001 mg/l) and as the concentration increased to 1 mg/l, the filterability of the Nalco 8172 rapidly decreased. The filterability of the activated silica water remained essentially constant and was 5-6× more filterable than the polymer water at a concentration of 1 mg/l. Even at a concentration of 1 mg/l activated silica, the water was substantially more filterable than the Nalco 8172 at 0.001 mg/l. In summary, the activated silica was more filterable than the Nalco 8172 at 1000× higher concentration. This is very significant. The graphs illustrating the results of these tests are in FIGS. 1-6.

### EXAMPLE 2

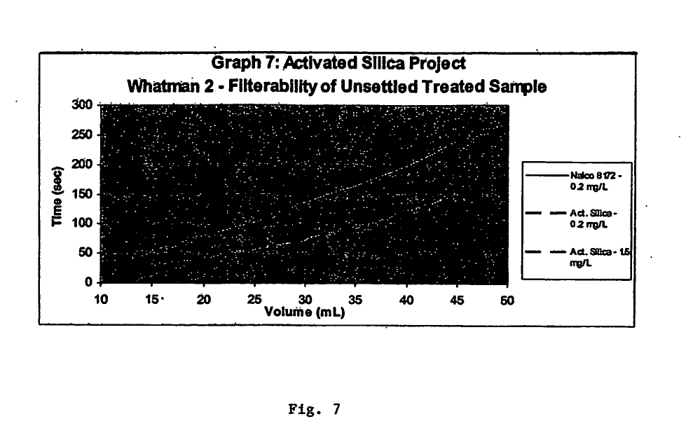

Filterability testing was also conducted utilizing a surface water of minimum turbidity and applying a ferric chloride dosage of 20 mg/l for coagulation. One set of samples was flocculated with 0.2 mg/l Nalco 8172. The other two sets were flocculated with 0.2 mg/l activated silica and 1.5 mg/l activated silica. The samples were not allowed to settle to simulate an upset clarifier with substantial carryover floc. The only difference in this test and the prior one was that the water to be filtered contained ferric hydroxide floc and perhaps a minimum amount of TOC in addition to the residual polymer or activated silica. Again, the results were better with activated silica, but the difference is not as substantial as in the case of the pure polymer or activated silica dissolved in water. There was a substantial difference for the Whatman 2 filter which was filtered by gravity. For the other two filters, the results with activated silica are only marginally better. The graphs illustrating the results are in FIG. 7.

What is claimed is:

1. A method of treating liquid containing at least one contaminant comprising:
mixing precipitant chemical with the liquid to cause a precipitation reaction and produce a precipitant;
introducing the precipitant and the liquid into a clarification device;
mixing activated silica with the precipitant and liquid to cause flocculation of the precipitant;
separating the liquid from flocculated precipitant; and
introducing the liquid into a membrane treatment device to cause a reduction of flocculated precipitant from the liquid.

2. The method of treating liquid of claim 1, wherein the precipitant chemical is at least one selected from the group consisting of ferric chloride, aluminum sulfate, calcium hydroxide, sodium hydroxide, sodium carbonate and polyaluminum salts.

3. The method of treating liquid of claim 1, further comprising causing flocculated precipitant to settle in the liquid before introducing the liquid into the membrane treatment device.

4. The method of treating liquid of claim 1, wherein the membrane treatment device contains at least one membrane.
